(19) United States
(12) Patent Application Publication
(10) Pub. No.: US 2026/0019344 A1
(43) Pub. Date: Jan. 15, 2026

(54) LIFE CYCLE MANAGEMENT OF AI/ML MODELS IN WIRELESS COMUNICATION SYSTEMS

(71) Applicant: Apple Inc., Cupertino, CA (US)

(72) Inventors: Huaning Niu, San Jose, CA (US); Dawei Zhang, Saratoga, CA (US); Hong He, San Jose, CA (US); Weidong Yang, San Diego, CA (US); Haitong Sun, Saratoga, CA (US); Oghenekome Oteri, San Diego, CA (US); Sigen Ye, San Diego, CA (US); Ankit Bhamri, Haar Bavaria (DE)

(21) Appl. No.: 18/995,239

(22) PCT Filed: Aug. 1, 2022
(86) PCT No.: PCT/CN2022/109456

§ 371 Date: Jan. 16, 2025

(51) Int. Cl. H04L 41/16; H04B 7/06; H04W 72/23

(52) U.S. Cl. CPC H04L 41/16; H04B 7/0626; H04W 72/23

(57) ABSTRACT

Apparatuses, systems, and methods for life cycle management of AI/ML models in wireless communication systems. A wireless device comprising at least one antenna and a processor is configured to: receive a Radio Resource Control (RRC) configuration message from a network device, the RRC configuration message indicating an Artificial Intelligence (AI) model to be used by the wireless device; and transmit an AI-based feedback message generated based on the AI model to the network device.

### TECHNICAL FIELD

This application relates generally to wireless communication systems, including apparatus, systems, and methods for life cycle management of AI/ML models in wireless communication systems.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Artificial intelligence (AI) is the simulation of human intelligence processes by machines, usually computer systems. Machine learning (ML) is a subset of AI that creates algorithms and statistical models to perform a specific task without using explicit instructions, relying instead on patterns and inference. ML algorithms build mathematical models based on sample data, called training data, to make predictions or decisions without being programmed specifically for that task. Learned signal processing algorithms can empower the next generation of wireless systems with significant reductions in power consumption and improvements in density, throughput, and accuracy when compared to the brittle and manually designed systems of today.

### SUMMARY

The present disclosure provides apparatuses, systems, and methods for life cycle management of AI/ML models in wireless communication systems.

Embodiments disclosed herein include a wireless device, comprising: at least one antenna; and a processor; wherein the wireless device is configured to: receive a Radio Resource Control (RRC) configuration message from a network device, the RRC configuration message indicating an Artificial Intelligence (AI) model to be used by the wireless device; and transmit an AI-based feedback message generated based on the AI model to the network device.

Embodiments disclosed herein include a network device, comprising: at least one antenna; and a processor; wherein the network device is configured to: transmit a Radio Resource Control (RRC) configuration message to a wireless device, the RRC configuration message indicating an Artificial Intelligence (AI) model to be used by the wireless device; and receive an AI-based feedback message generated based on the AI model from the wireless device.

Embodiments disclosed herein include a method performed by a wireless device, comprising: receiving a Radio Resource Control (RRC) configuration message from a network device, the RRC configuration message indicating an Artificial Intelligence (AI) model to be used by the wireless device; and transmitting an AI-based message generated based on the AI model to the network device.

Embodiments disclosed herein include a method performed by a network device, comprising: transmitting a Radio Resource Control (RRC) configuration message to a wireless device, the RRC configuration message indicating an Artificial Intelligence (AI) model to be used by the wireless device; and receiving an AI-based message generated based on the AI model from the wireless device.

Embodiments disclosed herein include a non-transitory computer-readable storage medium, having instructions stored thereon, which, when executed by a processor, cause a wireless device to: receive a Radio Resource Control (RRC) configuration message from a network device, the RRC configuration message indicating an Artificial Intelligence (AI) model to be used by the wireless device; and transmit an AI-based message generated based on the AI model to the network device.

Embodiments disclosed herein include a non-transitory computer-readable storage medium, having instructions stored thereon, which, when executed by a processor, cause a network device to: transmit a Radio Resource Control (RRC) configuration message to a wireless device, the RRC configuration message indicating an Artificial Intelligence (AI) model to be used by the wireless device; and receive an AI-based message generated based on the AI model from the wireless device.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3 illustrates an example functional framework of AI/ML in wireless communication systems, according to embodiments disclosed herein.

FIG. 4 illustrate an example communication procedure between a UE and a gNB for model training, according to embodiments disclosed herein.

FIG. 5 illustrates an example information structure of a NZP-CSI-RS-ResourceSet information element of a RRC configuration message.

FIG. 6 illustrates an example communication procedure between a UE and a gNB for model selection, according to embodiments disclosed herein.

FIG. 7 illustrates an example communication procedure between a UE and a gNB for model configuration, activation/de-activation and switching, according to embodiments disclosed herein.

FIG. 8 illustrates an example information structure of a reportQuantity parameter of a CSI-ReportConfig information element of a RRC configuration message.

FIG. 9 illustrates an example method performed by a wireless device for life cycle management of models, according to embodiments disclosed herein.

FIG. 10 illustrates an example method performed by a network device for life cycle management of models, according to embodiments disclosed herein.

### DETAILED DESCRIPTION

Various embodiments are described with regard to a UE. However, reference to a UE is merely provided for illustrative purposes. The example embodiments may be utilized with any wireless device that may establish a connection to a network and is configured with the hardware, software, and/or firmware to exchange information and data with the network. Therefore, the UE as described herein is used to represent any appropriate wireless device.

Various embodiments are described with regard to a gNB. However, reference to a gNB is merely provided for illustrative purposes. The example embodiments may be utilized with any network device in a network and is configured with the hardware, software, and/or firmware to implement any function of the network. Therefore, the gNB as described herein is used to represent any appropriate network device.

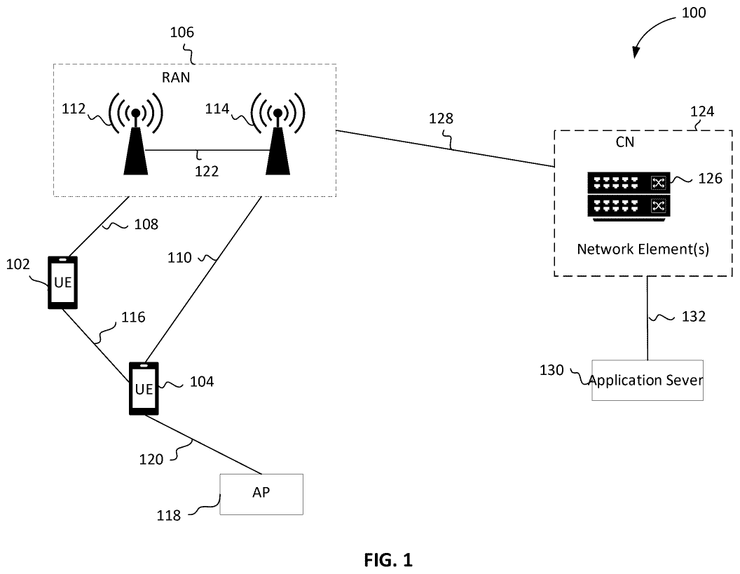

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VOIP sessions, group communication sessions, etc.) for the UE 102 and UE 104 via the CN 124. The application server 130 may communicate with the CN 124 through an IP communications interface 132.

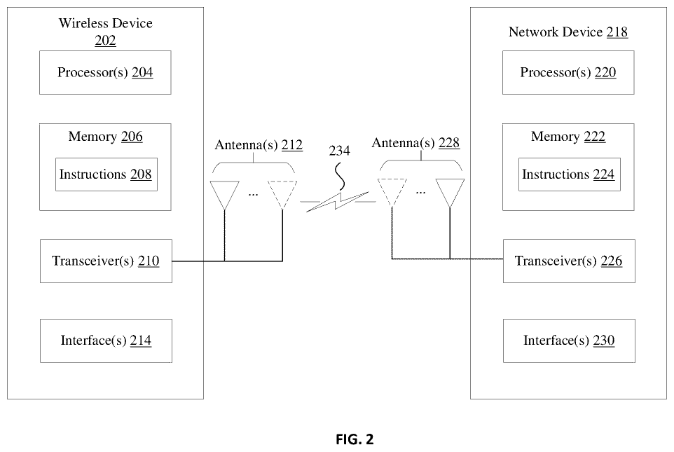

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

AI/ML can be applied to the wireless communication systems. Use cases include Channel State Information (CSI) feedback enhancement (e.g., overhead reduction, improved accuracy, and prediction), Beam Management (BM) (e.g., beam prediction in time, spatial domain for overhead and latency reduction, and beam selection accuracy improvement), and Positioning accuracy enhancements for different scenarios including, e.g., those with heavy NLOS conditions.

Embodiments contemplated herein provides life cycle management of AI/ML models in wireless communication systems. The life cycle management of AI/ML models includes, e.g., model training, model deployment, model inference (activation/de-activation/switching of AI/ML models), model monitoring, and model updating.

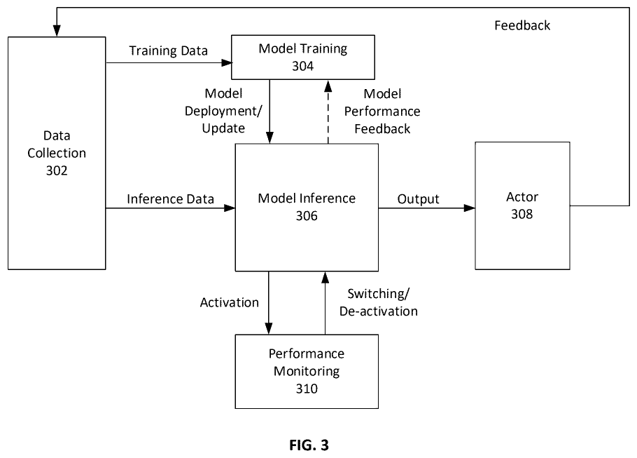

FIG. 3 illustrates an example functional framework of AI/ML in wireless communication systems, according to embodiments disclosed herein.

Data Collection 302 is a function that provides input data to Model training and Model inference functions. AI/ML algorithm specific data preparation (e.g., data pre-processing and cleaning, formatting, and transformation) is not carried out in the Data Collection function. Examples of input data may include measurements from UEs or different network entities, feedback from Actor, output from an AI/ML model. Training Data is data needed as input for the AI/ML Model Training function. Inference Data is data needed as input for the AI/ML Model Inference function.

Model Training 304 is a function that performs the AI/ML model training, validation, and testing which may generate model performance metrics as part of the model testing procedure. The Model Training function is also responsible for data preparation (e.g., data pre-processing and cleaning, formatting, and transformation) based on Training Data delivered by a Data Collection function, if required. Model Deployment/Update is to initially deploy a trained, validated, and tested AI/ML model to the Model Inference function or to deliver an updated model to the Model Inference function.

Model Inference 306 is a function that provides AI/ML model inference output (e.g., predictions or decisions). Model Inference function may provide Model Performance Feedback to Model Training function when applicable. The Model Inference function is also responsible for data preparation (e.g., data pre-processing and cleaning, formatting, and transformation) based on Inference Data delivered by a Data Collection function, if required. Output is the inference output of the AI/ML model produced by a Model Inference function. Details of inference output are use case specific. Model Performance Feedback may be used for monitoring the performance of the AI/ML model, when available.

Actor 308 is a function that receives the output from the Model Inference function and triggers or performs corresponding actions. The Actor may trigger actions directed to other entities or to itself. Feedback is information that may be needed to derive training data, inference data or to monitor the performance of the AI/ML Model and its impact to the network through updating of KPIs and performance counters.

Performance Monitoring 310 is a function that monitors performance of the AI/ML model. Performance Monitoring function may receive an activation signal from the model interference function indicating activation of AI/ML model. Performance Monitoring function may also provide switching/de-activation signal to the model interference function to switching/de-activate the AI/ML model.

Example communication procedures will be described below to illustrate various aspects of the present disclosure. The example communication procedures are described with regard to AI. However, reference to AI is merely provided for illustrative purposes, and it can be replaced with ML.

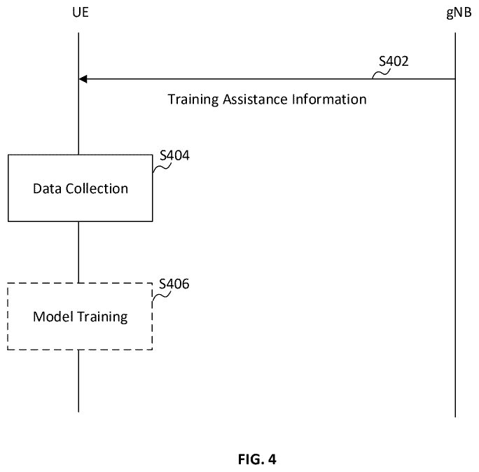

FIG. 4 illustrate an example communication procedure between a UE and a gNB for model training, according to embodiments disclosed herein. At step S402, the gNB transmits training assistance information to the UE to assist model training. At step S404, the UE performs data collection according to the training assistance information received from the gNB. UE can further sent the collected data to a UE vendor for model training. Alternatively, UE can perform model training by itself.

Numerous AI models may be applied in the wireless communication network. A particular AI model to be used may depend on, e.g., network deployment, use case, etc. Moreover, even if the same AI model is used, different weights may be required. Therefore, there is a need to categorize collected data into different AI training sets, so as to derive different weights from model training.

The training assistance information transmitted by the gNB may include, e.g., an AI training set ID, which indicate the AI training set that data collected by the UE should be added to. The UE adds collected data to the AI training set indicated by the AI training set ID in the training assistance information.

The AI training set ID may be included in a RRC configuration message transmitted from the gNB to the UE. The AI training set ID may be associated with a resource set ID, which indicates a resource set on which measurement is performed to collect data.

For a two sided model with CSI compression, the AI training set ID can be added in CSI-RS configuration from the network to assist UE data collection. For example, CSI-RS set configuration 1,2,3 may be corresponding to AI training set 1. This corresponds to a type of antenna to port mapping. The UE can include channel measurement based on that CSI-RS for training model weight 1. For another example, CSI-RS set configuration 4,5,6 may be corresponding to AI training set 2. This corresponds to COMP deployment. The UE can include channel measurement based on that CSI-RS for training model weight 2. When UE moves between different cells, CSI-RS configuration associated with the same AI set ID will assist UE to generate data set for different network configuration/deployment.

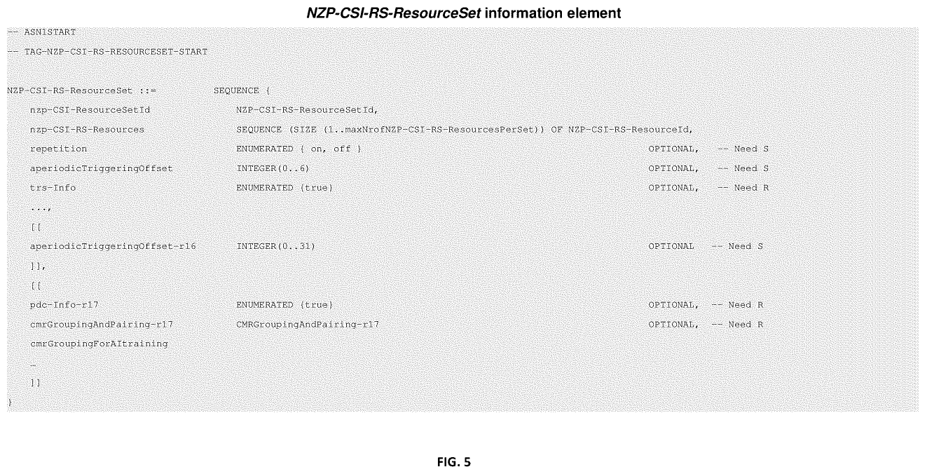

FIG. 5 illustrates an example information structure of a NZP-CSI-RS-ResourceSet information element of a RRC configuration message. The NZP-CSI-RS-ResourceSet information element comprises a parameter of cmrGroupingForAItraining to indicate the AI training set.

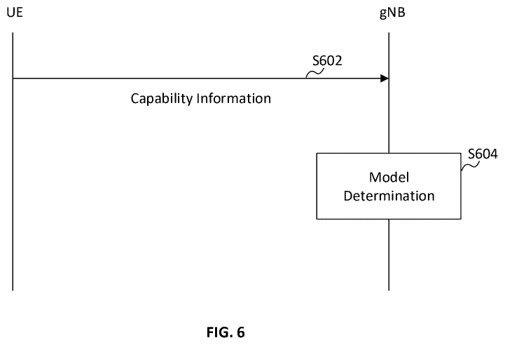

FIG. 6 illustrates an example communication procedure between a UE and a gNB for model determination, according to embodiments disclosed herein. At step S602, the UE transmits capability information to the gNB. The capability information may indicate a use case supported by the UE. At step S604, the gNB determine an AI model that can be used by the UE in the supported use case. In some instances, the gNB may retrieve the model ID corresponding to the supported use case from a database in a network. In some instances, the capability information may indicate the model ID corresponding to the supported use case. Therefore, the gNB may retrieve the model ID directly from the capability information.

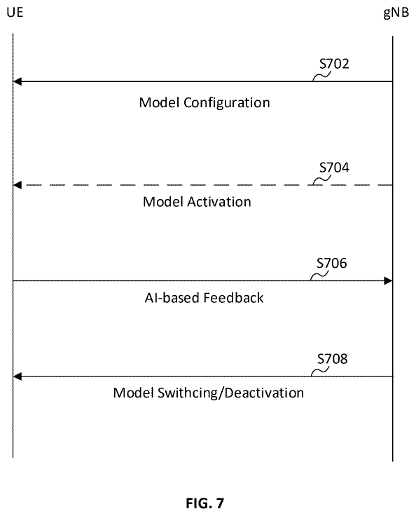

FIG. 7 illustrates an example communication procedure between a UE and a gNB for model configuration, activation/de-activation and switching, according to embodiments disclosed herein. At step S702, the gNB transmits a RRC configuration message to the UE for model configuration. The RRC configuration message indicates an AI model to be used by the UE. The RRC configuration message can be a use case configuration message or an AI-specific configuration message. The use case configuration message is a configuration message per use case. The AI-specific configuration message is a unified configuration message for different use cases.

In some instances, the AI model can be indicated implicitly in the RRC configuration message. For example, the AI model can be indicated by an AI-based codebook (e.g., CSI codebook) in the RRC configuration message. This can be done by adding new field in CodebookConfig structure. Current codebookConfig configure type-1 and type-2 codebook. One additional type-AI codebook can be added into the CodebookConfig structure. In some instances, the AI model can be indicated explicitly in the RRC configuration message. For example, the RRC configuration message may comprise a model ID to explicitly indicate the AI model. There can be a list of model IDs included in the RRC configuration message. Different model IDs may correspond to different use cases.

If meta data is used for model description of the AI model, the UE can derive model related parameters from the metadata associated with the model ID. For example, the model related parameters in the metadata may include training status, functionality/object, input/output for model, latency benchmarks, memory requirements, accuracy, compression status, inferencing/operating condition (e.g., urban, indoor, dense macro, etc.), preprocessing and post processing, etc.

Alternatively, the RRC configuration can include a full list of information, including model ID, use case (e.g., CSI compression, BM, positioning, etc.), input data for model (e.g., CSI-RS configuration for CSI, BM, Positioning Reference Signal (PRS)/Sounding Reference Signal (SRS) configuration for positioning), preprocessing and post processing for model (e.g., domain transfer information for CSI compression), model output content, size and feedback format, etc.

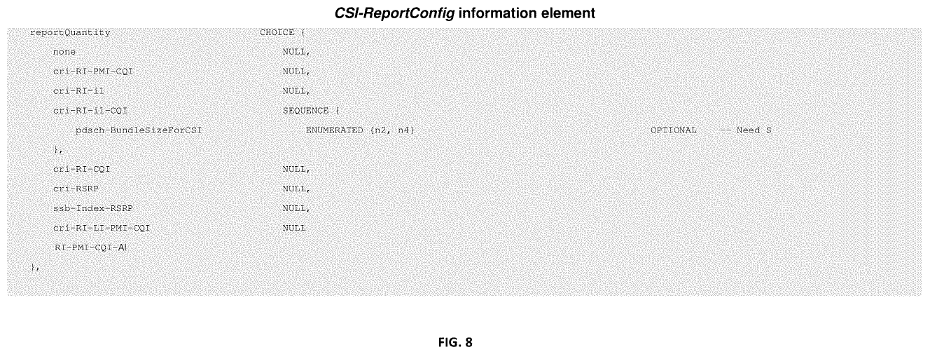

In some instances, the RRC configuration message for model configuration may comprise a report quantity field that indicates an AI-based report quantity to be fed back (e.g., format of the report quantity corresponding to the AI model). The report quantity varies per use case. For example, the report quantity can be CSI, positioning information, etc. FIG. 8 illustrates an example information structure of a reportQuantity parameter of a CSI-ReportConfig information element of a RRC configuration message. The reportQuantity parameter may be RI-PMI-CQI-AI indicating RI (Rank Indicator), PMI (Precoder-Matrix Indicator) and CQI (Channel-Quality Indicator) generated based on AI to be fed back as CSI. All the configurations of the structure of the reportQuantity parameter can be reused for MIMO feedback.

Returning back to FIG. 7. The UE may activate the AI model upon receipt of the RRC configuration message for model configuration. Alternatively, the gNB transmits a MAC (Media Access Control) CE (Control Element)/DCI (Downlink Control Information) message for model activation at step 704, and the UE activates the AI model upon receipt of the MAC CE/DCI. The MAC CE/DCI for model activation can comprise a model ID corresponding to the AI model to be activated.

Once the AI model is activated, the UE can generate and transmit an AI-based feedback message to the gNB at step S706. For example, the UE can perform measurement and generate the AI-based report quantity based on inference of the AI model, and comprise the AI-based report quantity in the AI-based feedback message.

Moreover, performance of the AI model can be monitored at the gNB or UE. In some instances, performance monitoring can be based on ACK/NACK feedback. For example, the gNB can determine that the performance of the AI model has degraded if DL (downlink) throughput drops. For another example, the UE can determine that the performance of the AI model has degraded if Physical Downlink Shared Channel (PDSCH) Block Error Rate (BLER) increases. The metric used for performance monitoring can be configured by the network.

In some instances, performance monitoring can be based on a traditional report quantity. For example, the AI-based feedback message can comprise an AI-based report quantity and a traditional report quantity for monitoring performance of the AI model. The gNB can compare the AI-based report quantity with the traditional report quantity for performance monitoring. The gNB can determine that the performance of the AI model has degraded if a difference between the AI-based report quantity and the traditional report quantity exceeds a threshold. The traditional report quantity can be transmitted periodic or aperiodic. If the traditional report quantity is transmitted aperiodically, it can be triggered when performance degradation is observed based on ACK/NACK feedback.

If it is decided to switch/de-activate the AI model (e.g., in response to performance degradation), the gNB can transmit a RRC reconfiguration message/MAC CE/DCI for model switching/de-activation at step S708. If multiple model IDs are configured in the RRC configuration message at step S702, model switching can be performed via a MAC CE/DCI comprising a new model ID of the multiple model IDs.

Moreover, when the UE fine tunes the AI model, the UE can transmit an updated AI model through UAI (UE assisted information) or MAC CE to the gNB. The network can assign a new model ID to the updated AI model or update the model description of the AI model.

Various embodiments are described above with regard to a UE and a gNB.

However, as indicated previously, the UE as described herein is used to represent any appropriate wireless device, and the gNB as described herein is used to represent any appropriate network device.

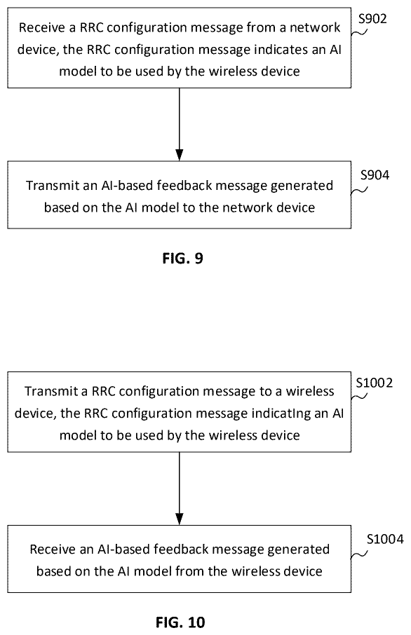

FIG. 9 illustrates an example method performed by a wireless device for life cycle management of models, according to embodiments disclosed herein. At step S902, the wireless device receives a Radio Resource Control (RRC) configuration message from a network device, the RRC configuration message indicating an Artificial Intelligence (AI) model to be used by the wireless device. At step S904, the wireless device transmits an AI-based feedback message generated based on the AI model to the network device. Any of the steps described above with reference to UE can be performed by the wireless device, and are not repeatedly described here for brevity's sake.

FIG. 10 illustrates an example method performed by a network device for life cycle management of models, according to embodiments disclosed herein. At step S1002, the network device transmits a Radio Resource Control (RRC) configuration message to a wireless device, the RRC configuration message indicating an Artificial Intelligence (AI) model to be used by the wireless device. At step S1004, the network device receives an AI-based feedback message generated based on the AI model from the wireless device. Any of the steps described above with reference to gNB can be performed by the network device, and are not repeatedly described here for brevity's sake.

Embodiments contemplated herein include a wireless device, comprising: at least one antenna; and a processor; wherein the wireless device is configured to: receive a Radio Resource Control (RRC) configuration message from a network device, the RRC configuration message indicating an Artificial Intelligence (AI) model to be used by the wireless device; and transmit an AI-based feedback message generated based on the AI model to the network device.

In some embodiments of the present disclosure, the RRC configuration message comprises a model ID of the AI model.

In some embodiments of the present disclosure, the RRC configuration message comprises a report quantity field that indicates an AI-based report quantity to be fed back.

In some embodiments of the present disclosure, the report quantity is channel state information or positioning information.

In some embodiments of the present disclosure, the wireless device is further configured to transmit capability information to the network device, the capability information indicating a use case supported by the wireless device and the model ID corresponding to the use case.

In some embodiments of the present disclosure, the wireless device is further configured to activate the AI model based on the RRC configuration message.

In some embodiments of the present disclosure, the wireless device is further configured to activate the AI model based on a Media Access Control (MAC) Control Element (CE) or a Downlink Control Information (DCI) received from the network device.

In some embodiments of the present disclosure, the wireless device is further configured to monitor performance of the AI model based on Physical Downlink Shared Channel (PDSCH) Block Error Rate (BLER).

In some embodiments of the present disclosure, the AI-based feedback message comprises an AI-based report quantity and a traditional report quantity for monitoring performance of the AI model.

In some embodiments of the present disclosure, the wireless device is further configured to switch to another AI model based on one of an RRC reconfiguration message, a MAC CE, or DCI.

In some embodiments of the present disclosure, the wireless device is further configured to report an updated AI model to the network device by User Assisted Information (UAI) or a MAC CE.

In some embodiments of the present disclosure, the wireless device is further configured to collect measurement data for training of the AI model based on an AI training set ID received from the network device.

Embodiments contemplated herein include an apparatus comprising means to perform one or more elements of the method comprising: receiving a Radio Resource Control (RRC) configuration message from a network device, the RRC configuration message indicating an Artificial Intelligence (AI) model to be used by a wireless device; and transmitting an AI-based message generated based on the AI model to the network device. This apparatus may be, for example, an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of the method comprising: receiving a Radio Resource Control (RRC) configuration message from a network device, the RRC configuration message indicating an Artificial Intelligence (AI) model to be used by a wireless device; and transmitting an AI-based message generated based on the AI model to the network device. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of the method comprising: receiving a Radio Resource Control (RRC) configuration message from a network device, the RRC configuration message indicating an Artificial Intelligence (AI) model to be used by a wireless device; and transmitting an AI-based message generated based on the AI model to the network device. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the method comprising: receiving a Radio Resource Control (RRC) configuration message from a network device, the RRC configuration message indicating an Artificial Intelligence (AI) model to be used by a wireless device; and transmitting an AI-based message generated based on the AI model to the network device. This apparatus may be, for example, an apparatus of a UE (such as a wireless device 202 that is a UE, as described herein).

Embodiments contemplated herein include a signal as described in or related to one or more elements of the method comprising: receiving a Radio Resource Control (RRC) configuration message from a network device, the RRC configuration message indicating an Artificial Intelligence (AI) model to be used by a wireless device; and transmitting an AI-based message generated based on the AI model to the network device.

Embodiments contemplated herein include a computer program or computer program product comprising instructions, wherein execution of the program by a processor is to cause the processor to carry out one or more elements of the method comprising: receiving a Radio Resource Control (RRC) configuration message from a network device, the RRC configuration message indicating an Artificial Intelligence (AI) model to be used by a wireless device; and transmitting an AI-based message generated based on the AI model to the network device. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

Embodiments contemplated herein include a network device, comprising: at least one antenna; and a processor; wherein the network device is configured to: transmit a Radio Resource Control (RRC) configuration message to a wireless device, the RRC configuration message indicating an Artificial Intelligence (AI) model to be used by the wireless device; and receive an AI-based feedback message generated based on the AI model from the wireless device.

In some embodiments of the present disclosure, the RRC configuration message comprises a model ID of the AI model.

In some embodiments of the present disclosure, the RRC configuration message comprises a report quantity field that indicates an AI-based report quantity to be fed back.

In some embodiments of the present disclosure, the report quantity is channel state information or positioning information.

In some embodiments of the present disclosure, the network device is further configured to determine the AI model based on capability information received from the network device.

In some embodiments of the present disclosure, the capability information indicates a use case supported by the wireless device and the model ID corresponding to the use case.

In some embodiments of the present disclosure, the network device is further configured to transmit a Media Access Control (MAC) Control Element (CE) or a Downlink Control Information (DCI) to the wireless device for activating the AI model.

In some embodiments of the present disclosure, the network device is further configured to monitor performance of the AI model based on an Acknowledgement (ACK) message or a Negative Acknowledgement (NACK) message.

In some embodiments of the present disclosure, the AI-based feedback message comprises an AI-based report quantity and a traditional report quantity for monitoring performance of the AI model.

In some embodiments of the present disclosure, the network device is further configured to transmit one of an RRC reconfiguration message, a MAC CE, or DCI to the wireless device for switching to another AI model.

In some embodiments of the present disclosure, the network device is further configured to receive an updated AI model from the wireless device by User Assisted Information (UAI) or a MAC CE.

In some embodiments of the present disclosure, the network device is further configured to assign a new model ID to the updated AI model or update model description of the AI model.

In some embodiments of the present disclosure, the network device is further configured to transmit an AI training set ID to the wireless device for collecting measurement data for training of the AI model.

Embodiments contemplated herein include an apparatus comprising means to perform one or more elements of the method comprising: transmitting a Radio Resource Control (RRC) configuration message to a wireless device, the RRC configuration message indicating an Artificial Intelligence (AI) model to be used by the wireless device; and receiving an AI-based feedback message generated based on the AI model from the wireless device. This apparatus may be, for example, an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of the method comprising: transmitting a Radio Resource Control (RRC) configuration message to a wireless device, the RRC configuration message indicating an Artificial Intelligence (AI) model to be used by the wireless device; and receiving an AI-based feedback message generated based on the AI model from the wireless device. This non-transitory computer-readable media may be, for example, a memory of a base station (such as a memory 222 of a network device 218 that is a base station, as described herein).

Embodiments contemplated herein include an apparatus comprising logic, modules, or circuitry to perform one or more elements of the method comprising: transmitting a Radio Resource Control (RRC) configuration message to a wireless device, the RRC configuration message indicating an Artificial Intelligence (AI) model to be used by the wireless device; and receiving an AI-based feedback message generated based on the AI model from the wireless device. This apparatus may be, for example, an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of the method comprising: transmitting a Radio Resource Control (RRC) configuration message to a wireless device, the RRC configuration message indicating an Artificial Intelligence (AI) model to be used by the wireless device; and receiving an AI-based feedback message generated based on the AI model from the wireless device. This apparatus may be, for example, an apparatus of a base station (such as a network device 218 that is a base station, as described herein).

Embodiments contemplated herein include a signal as described in or related to one or more elements of the method comprising: transmitting a Radio Resource Control (RRC) configuration message to a wireless device, the RRC configuration message indicating an Artificial Intelligence (AI) model to be used by the wireless device; and receiving an AI-based feedback message generated based on the AI model from the wireless device.

Embodiments contemplated herein include a computer program or computer program product comprising instructions, wherein execution of the program by a processing element is to cause the processing element to carry out one or more elements of the method comprising: transmitting a Radio Resource Control (RRC) configuration message to a wireless device, the RRC configuration message indicating an Artificial Intelligence (AI) model to be used by the wireless device; and receiving an AI-based feedback message generated based on the AI model from the wireless device. The processor may be a processor of a base station (such as a processor(s) 220 of a network device 218 that is a base station, as described herein). These instructions may be, for example, located in the processor and/or on a memory of the base station (such as a memory 222 of a network device 218 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A wireless device, comprising:
at least one antenna;
a transceiver coupled to the at least one antenna;
a memory; and
a processor configured to, when executing instructions stored in the memory, cause the wireless device to:
receive, via the transceiver, a Radio Resource Control (RRC) configuration message from a network device, the RRC configuration message indicating an Artificial Intelligence (AI) model to be used by the wireless device; and
transmit, via the transceiver, an AI-based feedback message generated based on the AI model to the network device.

2. The wireless device of claim 1, wherein the RRC configuration message comprises a model ID of the AI model.

3. The wireless device of claim 1, wherein the RRC configuration message comprises a report quantity field that indicates an AI-based report quantity to be fed back.

4. The wireless device of claim 3, wherein the AI-based report quantity is channel state information or positioning information.

5. The wireless device of claim 1, wherein the processor is further configured to cause the wireless device to:
transmit capability information to the network device, the capability information indicating a use case supported by the wireless device and a model ID corresponding to the use case.

6. The wireless device of claim 1, wherein the processor is further configured to cause the wireless device to:
activate the AI model based on the RRC configuration message.

7. (canceled)

8. The wireless device of claim 1, wherein the processor is further configured to cause the wireless device to:
monitor performance of the AI model based on Physical Downlink Shared Channel (PDSCH) Block Error Rate (BLER).

9. The wireless device of claim 1, wherein the AI-based feedback message comprises an AI-based report quantity and a traditional report quantity for monitoring performance of the AI model.

10. (canceled)

11. (canceled)

12. The wireless device of claim 1, wherein the processor is further configured to cause the wireless device to:
collect measurement data for training of the AI model based on an AI training set ID received from the network device.

13. A network device, comprising:
at least one antenna;
a transceiver coupled to the at least one antenna;
a memory; and
a processor configured to, when executing instructions stored in the memory, cause the network device to:
transmit, via the transceiver, a Radio Resource Control (RRC) configuration message to a wireless device, the RRC configuration message indicating an Artificial Intelligence (AI) model to be used by the wireless device; and
receive, via the transceiver, an AI-based feedback message generated based on the AI model from the wireless device.

14. (canceled)

15. The network device of claim 13, wherein the RRC configuration message comprises a report quantity field that indicates an AI-based report quantity to be fed back, and wherein the AI-based report quantity is channel state information or positioning information.

16. (canceled)

17. The network device of claim 13, wherein the processor is further configured to cause the network device to:
determine the AI model based on capability information received from the network device, wherein the capability information indicates a use case supported by the wireless device and a model ID corresponding to the use case.

18. (canceled)

19. The network device of claim 13, wherein the processor is further configured to cause the network device to:
transmit a Media Access Control (MAC) Control Element (CE) or a Downlink Control Information (DCI) to the wireless device for activating the AI model.

20. The network device of claim 13, wherein the processor is further configured to cause the network device to:
monitor performance of the AI model based on an Acknowledgement (ACK) message or a Negative Acknowledgement (NACK) message.

21. The network device of claim 13, wherein the AI-based feedback message comprises an AI-based report quantity and a traditional report quantity for monitoring performance of the AI model.

22. The network device of claim 13, wherein the processor is further configured to cause the network device to:
transmit one of an RRC reconfiguration message, a Media Access Control (MAC) Control Element (CE), or Downlink Control Information (DCI) to the wireless device for switching to another AI model.

23. The network device of claim 13, wherein the processor is further configured to cause the network device to:
receive an updated AI model from the wireless device by User Assisted Information (UAI) or a MAC CE.

24. The network device of claim 23, wherein the processor is further configured to cause the network device to:
assign a new model ID to the updated AI model or update a model description of the AI model.

25. (canceled)

26. A baseband processor configured to perform operations comprising:
receiving a Radio Resource Control (RRC) configuration message from a network device, the RRC configuration message indicating an Artificial Intelligence (AI) model to be used by the baseband processor; and
sending an AI-based message generated based on the AI model to the network device.

27-29. (canceled)

30. The wireless device of claim 1, wherein the RRC configuration message includes a Channel State Information (CSI)-ReportConfig information element that indicates an AI-based report quantity to be generated using the AI model and included in the AI-based feedback message.
